(19) United States
(12) Patent Application Publication
(10) Pub. No.: US 2007/0133840 A1
(43) Pub. Date: Jun. 14, 2007

(54) Tracking Using An Elastic Cluster of Trackers

(75) Inventor: Andrew Cilia, McKinney, TX (US)

Correspondence Address: HUSCH & EPPENBERGER, LLC, 190 CARONDELET PLAZA, SUITE 600, ST. LOUIS, MO, 63105-3441, US

(73) Assignee: Clean Earth Technologies, LLC, Earth City, MO (US)

(21) Appl. No.: 11/556,896

(22) Filed: Nov. 6, 2006

Related U.S. Application Data
(60) Provisional application No. 60/733,398, filed on Nov. 4, 2005.

(51) Int. Cl. G06K 9/00

(52) U.S. Cl. 382/103

(57) ABSTRACT

The invention is method for tracking moving objects from data by tracking a cluster of resilient features of the target. The features correspond to a set of trackers, to maintain tracking or allow rapid reacquisition and subsequent tracking although the objects' form and geometry may change. The method includes a Motion Fields Extraction step, a Creation of the Elastic Matrix step, and a step including the recurring tracking of the target. The Motion Fields Extraction step further includes generating Candidate Matches, Localizing Motion Voting, and Resolving Voting, and the Creating the Elastic Matrix step includes the steps of Creating the Candidate Targets, Assessing the Target Quality of the Candidate Targets, and Creating the Elastic Matrix.

### CROSS-REFERENCE TO RELATED APPLICATIONS

This application claims priority from U.S. Provisional Patent Application No. 60,733,398 filed Nov. 4, 2005 which is herein incorporated by reference.

### STATEMENT REGARDING FEDERALLY SPONSORED RESEARCH

Not Applicable.

### APPENDIX

Not Applicable.

### FIELD OF THE INVENTION

The present invention is in the field of methods for tracking objects, which may be non-rigid objects, and that may be moving in complex, cluttered environments, especially in multi-dimensional situations where the object being tracked, any of the tracked targets, may be occluded by another object between the viewer or sensor and the target. Examples of objects to be tracked are humans, animals, vehicles, tactical military equipment, parts in a factory, and in vivo objects in tissue. Among such methods are those that pertain to tracking humans or parts thereof, or groups of humans in images, video scenes, or maps, which are generated by optical, electro-optical, radar and other sensor systems and devices.

### BACKGROUND OF THE INVENTION

Tracking objects by optical, electro-optical, radar systems, and other sensors is important in security, surveillance and reconnaissance, traffic and flow control, industrial and healthcare applications. Common problems encountered in tracking objects, referred to as the targets, are the occlusion of the target object when another object is situated between the sensor and the target, the dynamic variation of the target morphology, e.g., the relative motion of limbs, head and torso while walking or during other movement, variation and diversity in lighting, and the non-uniformity of motion of the target and its parts. Prior art has addressed many of these problems with various degrees of success, complexity, and accuracy. For some situations, such as for synthetic aperture radar mapping of a large area and the detection and tracking of numerous moving targets, very elaborate tracking methods have shown considerable success. However, for imaging systems, the automatic tracking of individual persons as they move through a dynamically changing scene poses the challenges to avoid loss of ‘locking’ on the target, to maintain or reacquire tracking as the target moves erratically, adds or subtracts garments or picks up packages or performs other actions that will change appearance and form, and to perform accurate tracking with sufficiently efficient and rapid information processing so that real-time or near-real-time use of the tracking information can be made, e.g., the graphical display of the track in an image.

Prior art includes many examples of tracking methods, schemes, and techniques, which include motion prediction, pixel correlations, probabilistic data association, association or clustering of sets of objects or features, cost minimization function methods, expectation-maximization methods, and looping or iteration through a sequence of algorithms and process steps. Some of these steps include thresholding, filtering (including multiple particle filtering), track association, and multiple layers of objects, e.g., foreground and background. Tracking of clusters of features has been extensively applied to variations and extensions of the classic Kanade, Lucas, Tomasi (often called the “KLT”) tracking scheme, which allows for translation, rotation, and deformation of a target. KLT trackers work well for small displacements and for a limited amount of occlusion. Recently, schemes for improved feature selection and retention that are based on a feature quality test have been reported. These schemes have been applied to non-rigid object tracking that is model based. Mathes and Piater describe such a tracking method that selects salient feature points as a point distribution model in which a manifold of shapes is updated as points appear or disappear as the target performs out-of-plane rotations and strong non-rigid deformations. Their model uses shapes defined by the local appearance of features on the target instead of raw texture information, e.g., spatial frequency of intensity. However, the prior art does not teach efficient means to minimize the effects of severe target object occlusion, diverse lighting, and of changes in appearance and number of associated features and objects with the target object.

Others in the prior art have used connected operators to link similar portions of the image. Inouchi and McLoughlin explored the use of connectionist models in an attempt to address the occlusion problem. Utilizing neural networks to recall the token color and texture properties, token relationships were established that associated tokens belonging to the same target. Later, Marques, Vilaplana and Buxes applied the technique to segment and track human faces by establishing a connectivity operator among the video segments most likely to contain a human face. A Binary Partition Tree holds and sorts the connected segments throughout the tracking sequence, filling in missing information as needed (generally due to self-occlusion or foreground occlusions). Chiba et al used the sum of squared differences (SSD) method applied to patches of the image, selected high confidence patches, estimated the optical flow, and then applied the KLT hierarchy to tracking. However, none of the prior methods has shown consistently reliable tracking when severe target occlusion occurs and during extensive target deformation or significant change or loss of many of its features.

It is the object of the present invention to overcome the limitations of the prior art in the tracking of rigid, non-rigid, and feature-changing targets in a scene that may have severe occlusion, diverse lighting, and a context that may range from nearly featureless to high clutter. It is further the object of the present invention to provide reliable tracking of targets in scenes with regions of shadow, abrupt change in target direction, and the cross-over of two or more tracked targets. It is still further the object of the present invention to allow the use of dissimilar textural target features, to account for feature quality by a weighted voting framework that favors higher velocity correlation, and to provide an elastic framework that supports the predictive tracking of lost or degraded features during severe target deformation and occlusion by foreground objects.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### SUMMARY OF THE INVENTION

This invention is a method of tracking target objects, which may be non-rigid target objects, e.g., humans, in complex, cluttered environments in which the view of the target may be subject to severe or complete occlusion by objects between the viewer (i.e., imaging sensor, camera, or radar) and the target. The method, called the Elastic Cluster Tracker, uses insulated small patches as features that are identified and retained or discarded according to the correlation of their motion and spatial relationship with the track of the target. The tracking process is initiated with two successive video frames. In the first frame, a target designation window is constructed around the target to define a region of interest of the image containing the target. This window may be constructed by a human operator or may be generated from the results of an automated target recognition (ATR) algorithm. Multiple targets may be designated by constructing multiple windows, one enclosing each target. The subsequent tracking process then comprises the following three steps:

1) Motion Field Extraction
The Motion Fields Extraction process comprises the steps: (1) Generate Candidate Matches, (2) Localized Motion Voting, and (3) Voting Resolution.

2) Creation of the Elastic Matrix
The creation of the Elastic Matrix comprises the three major process steps: (1) Creating the Candidate Targets, (2) Assessing the Feature Quality of the Candidate Features, and (3) Creating the Elastic Matrix

3) The Recurring Tracking of the target with up-dating of the Elastic Matrix, Elastic Matrix Relationships, and the Motion Field.

In the Motion Field Extraction step, the motion of patches that are image segments of a grid within an initially designated target window is determined by calculating the pixel-by-pixel convolution values to construct correlation surfaces for candidate matches (patches) in the succeeding video frame with each patch in the preceding frame. The segments correspond to ‘kernels’ of specified size in contrast to many prior tracking schemes in which specific shapes, textures, colors, or other characteristics are selected a priori as tracking features. A weighted, layered, four-dimensional (4-D, e.g., “phase space” comprising 2 spatial components, x, y, and 2 velocity components, u,v) voting scheme is used with voting resolution that collects votes in a limited neighborhood of each kernel in the image grid to determine the highest quality kernel track and accordingly the velocity vector in the Motion Field.

Then Elastic Matrix Creation is performed. A target cluster is generated by segmentation (partition) of the target designation window in the first frame and Candidate Targets are evaluated for the quality of their track and correlation with the expected motion as predicted by the Motion Field. Individual members of the target cluster are referred to as “Trackers”. Background and target segments are identified, e.g., background segments may be static, so that background segments may not be considered further. Deviant Trackers also are dismissed from further consideration. The remaining Trackers are grouped by the similarity of their motion and the Elastic Matrix is generated for the member set of Trackers and their nearest neighbors. Each node of the matrix contains the position in phase space and information about the quality and persistence of each member. Also, for each pair of Candidate Targets, an Elastic Matrix Relationship is determined that predicts the position of either member of the pair in case it is occluded or disappears.

Recurring Tracking is then performed for successive video frames. Intensity based convolution operations provide correlation surfaces. Least Square Error tracking is performed by minimization of errors on the correlation surfaces to find the best match. Weighted amalgamation is used to combine the tracking data of a small cluster of Trackers to obtain a larger effective aperture. The weights are a function of the amplitude of the corresponding correlation peak. Vote tallying is performed to identify nodes in the Elastic Matrix with similar motion vectors. The velocity pair layer with the most support decides the tracking results for each Tracker. Next the Motion Field, Elastic Matrix, and Elastic Matrix Relationships are updated.

Reliable, high quality tracking results by use of continually updating the prediction of target motion in combination with the tracking of an elastic target cluster. The degradation, disappearance or reappearance of Trackers is accommodated by this process. Further, the use of image patches as features avoids the need for a priori defined features as characteristic shapes, corners, colors, or other specific features of the target. This approach provides high tracking reliability in heavily cluttered environments because of its ability to maintain track-lock on objects even when they are severely obscured. The Elastic Matrix framework supports a flexible structured model of the non-rigid target. This method allows the tracker to follow the deformations of the target's body and to estimate feature locations when occluded.

The Elastic Cluster Tracker has several important characteristics. These are:
Tracking of resilient features rather than the whole target
Automatic ranking of target features by track quality
Motion segmentation by a Motion Field algorithm
Combine optical flow tracking with tracking guidance from the Motion Fields
Target cohesiveness through the use of a non-model structured Elastic Matrix to predict the position of occluded features
Target spawning based on grouping of similar feature behaviors

### BRIEF DESCRIPTION OF THE DRAWINGS

The present invention will become more fully understood from the detailed description and the accompanying drawings, wherein:

FIG. 1. The Elastic Cluster Tracker is used to track a person. Shown is a person, the object to be tracked, with several candidate targets (features) with motion and attributes that are captured in an Elastic Matrix that describes their temporal-spatial correspondences.

FIG. 2. Motion Fields are used to evaluate candidate members of a target cluster. The target object is shown with motion vectors that comprise the local motion fields on and around the target.

FIG. 3. A set of Candidate Targets is created. Salient features of the target are selected for tracking based on the feature's target quality indicators.

FIG. 4. An Elastic Matrix is created. Temporal-spatial relationships among candidate targets are established and maintained in a data structure called the Elastic Matrix. Relationships are displayed as lines between the candidate targets.

FIG. 5. Tracking based on the Elastic Matrix is performed. This sequence illustrates the tracking process using an Elastic Matrix. The Matrix maintains the cohesiveness of the cluster of trackers while allowing each tracker to follow its marker.

FIG. 6. Tracking is performed through foreground occlusions. This sequence illustrates the Elastic Cluster Tracker's ability to track through several foreground occlusions.

FIG. 7. Tracking is performed through an obscuration. Shown are two real-life tracking sequences of maneuvering targets in an uncontrolled occluded environment.

FIG. 8. A pedestrian is tracked outdoors. This tracking sequence shows the tracker following a pedestrian through a severe hard occlusion and through a severe partial occlusion.

FIG. 9. Persons shopping at a mall and in a skating rink are tracked. Shown are four real-life examples of the simultaneous tracking of individuals in an uncontrolled crowded environment.

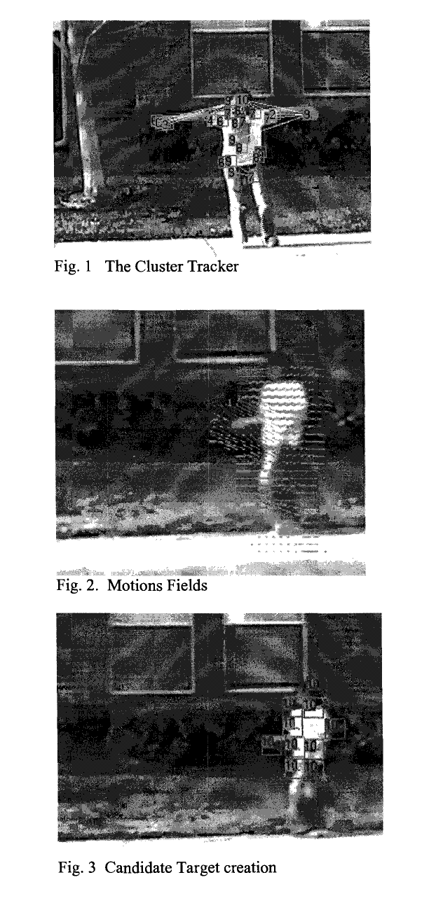

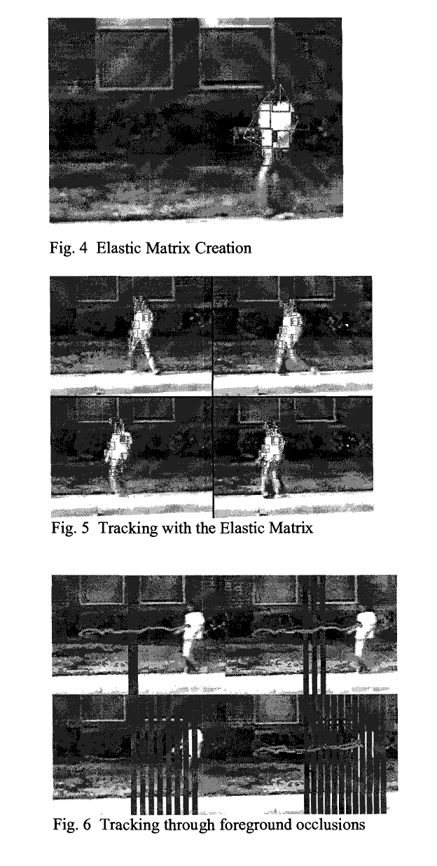

### DETAILED DESCRIPTION OF THE INVENTION

Motion Fields extraction is an optical flow process that calculates the local motion at all points of the input video frame. The local motions are used to validate targets during the cluster creation and to guide the trackers during the recurring tracking of the target.

The target acquisition process is initiated by either a human operator or by an Automatic Target Recognition (ATR) process external to the tracker. Inputs to the algorithm consist of two consecutive frames of video plus a region-of-interest (ROI) designator that encloses the area where the target is present.

1) Motion Fields Extraction

In a process similar to the one described by Mircea Nicolascu, the scene's local motion is extracted by a process called Motion Fields Extraction. The results are stored in an array of local motion descriptors used to both validate extracted candidate targets and to guide the tracking process during the initial phases of target tracking.

The Motion Fields Extraction process is composed of the following steps: Generate Candidate Matches, Localized Motion Voting, and Voting Resolution.

2) Generate Candidate Matches

To generate the Candidate Matches, subdivide each ROI of the first video frame using a fine grid comprising segments that contain several contiguous pixels. For every segment of the grid, execute a convolution search (based on intensity and or color) on the second video frame. Using several kernel sizes can yield better defined motion descriptors. This may result by the greater suitability of smaller kernels in regions close to motion boundaries, and by the greater suitability of larger kernels for larger areas of little texture. In a preferred embodiment, for diverse features that are characteristically several pixels in extent, the best results are obtained by using the three kernel sizes: 5×5, 7×7, and 9×9 pixels.

The entire set of results of the convolution search are retained as the entire correlation surfaces of all the candidate matches, in contrast to the method of Nicolascu in which only the correlation peaks are retained. Keeping the entire correlation surfaces, a greatly simplified tensor voting scheme can be used effectively.

3) Localized Motion Voting

The aperture of several neighboring kernels are combined to reinforce common traits while eliminating the noise inherent of low aperture trackers. This avoids a well-known difficulty that is otherwise encountered when using small kernels to deduce the local motion in a scene. This difficulty results because the smaller kernels don't contain enough pixels to uniquely locate the corresponding image on the new frame. The aperture of each of the kernels is simply too small, and, therefore, it is restricted by the optical flow constraint equation:

$$v \cdot ▽ I + \frac{\partial I}{\partial t} = 0 , \qquad ( 1 )$$

where I is the intensity, v is the velocity, and t is time. Image sections that are too small may not have sufficient local intensity gradients for the convolution to work. Consequently, the combining of neighboring kernels may be advantageous. A variety of voting schemes are available to exploit such combined apertures. A preferred embodiment uses a voting framework that is modeled on a simplified version of the Layered 4-D Tensor voting framework.

Using a Layered 4-D Tensor Voting system, each potential match is encoded into a 4-D tensor as follows: the tensor is located in the 4-D space given by the point (x, y, vₓ, v_{y}) and described by a set of eigenvectors and eigenvalues where each potential match is encoded into a 4-D ball tensor. The ball tensor does not show preference for any particular direction. After encoding, each token propagates its preferred information to its neighbors through several steps of voting; the voting range is determined by a scale factor controlled by the operator. The vote strength decays with distance and orientation in a way such that smooth surface continuities are encouraged. The vote orientation corresponds to be best possible local surface continuation from voter to recipient.

The voting process gives strong support to tokens with similar motion parameters, that is, they lie on the same or on close-by layers (velocity descriptors) while communication among tokens with different motion attributes is inhibited by the layer separation in the 4-D space. Wrong matches appear as isolated points that receive little support.

Our modification to the 4-D Tensor Voting scheme allows all points on the correlation surface to vote (not only the peaks) by simplifying the definition of the 4-D ball tensor voting field. By this means, the vote strength depends not only on the distance and the orientation, but also on the magnitude of the point at the voting tracker's correlation surface. Instead of generating a tensor framework to define the voting field, instead simply limit the radius of the voting neighborhood to the point where the distance decay would render votes insignificant. This yields a remarkable improvement on computational efficiency.

4) The Weighted Voting Framework

To effectively address the problem of motion analysis, the computational framework must be able to infer local motion information from the available data while taking into account and handling the restrictions caused by the limited aperture of the small kernels.

The simplest voting scheme consists of adding the correlation surfaces of neighboring kernels, which is equivalent to using a larger kernel:

$$\begin{matrix}{C}_{uv} = {\sum }_{x} {\sum }_{y} {( {T}_{xy} - {V}_{( x + u ) ( y + v ) )} )}^{2} \\ = {\sum }_{n} {\sum }_{{x}_{n}} {\sum }_{{y}_{n}} {( {T}_{xy} - {V}_{( x + u ) ( y + v )} )}^{2} ,\end{matrix} \qquad ( 2 )$$

where each of the elements of the correlation matrix Cᵤᵥ is calculated from the convolution of the target template T_{xy} and the incoming video frame V_{xy}. Some kernels will provide higher-quality tracking data while others provide little or even erroneous data, because the quality of the motion information is related to intensity gradient by the optical flow constrain equation (1) and therefore highly dependent of imagery content assigned to each kernel, A kernel assigned an area of little texture will not be able to discern any motion, while a kernel tracking a prominent feature will provide the most accurate measurements. A kernel whose target goes into occlusion most likely will provide an erroneous output as it attempts to match its template to an image that does not contain the target.

The quality of the kernel track can be measured in several ways, for example, the magnitude of the Least Sum of Square Errors can be used to segregate kernels with poor image matches. Alternatively, the number and the slope of the correlation peaks can be analyzed to identify kernels with sufficient optical flow. To convert the magnitude of the correlation peak (which may also appear as a notch) into a weight function that accounts for the correlation peak and the distance to the voting kernel, a quality weight can be defined as:

$${W}_{q} ( n ) = exp \{ - ( \frac{{d}_{n} \sqrt{{ρ}_{n}}}{σ} ) \} , \qquad ( 3 )$$

where the quality weight W_{q} is expressed in term of the is the correlation peak pₙ, σ is the weight function scale factor, and the distance dₙ for kernel n. Intuitively, it follows that when the correlation peak is zero, or there are no differences between the kernel template and the image segment, the probability of finding the kernel somewhere in the image is one. As the errors increase at the best match location, the probability of finding the kernel in the search area lowers and therefore the weight should be lower. The distance to each of the neighboring kernels in the voting group is also important since the influence of the kernel diminishes with distance, so for larger distances the weight value diminishes rapidly.

The weight function is used in the voting operation so that the kernels with higher quality will have more influence than kernels with lower quality. Equation (4) is the correlation surface as a weighed function:

$${C}_{uv} = \frac{{\sum }_{n} {W}_{n} {\sum }_{x} {\sum }_{y} {( {T}_{xy} - {V}_{( x + u ) ( y + v )} )}^{2}}{{\sum }_{n} {W}_{n}} . \qquad ( 4 )$$

The resulting correlation surface Cᵤᵥ is the product of the quality-weighted voting function of the surrounding kernels. Each of the values in Cᵤᵥ holds the votes that support a target track to the location [u,v]. It should be noted that Equation (4) is calculated independently for every possible pixel velocity within the search range [u,v], maintaining the layer separation as defined in the layered 4-D voting algorithm.
5) Voting Resolution

Each kernel in the image grid collects votes from its neighboring kernels up to a maximum distance defined by the weight function scale factor. After its own vote is added, a search is made for the velocity pair with the most support. Since the votes are derived from the sum of squared errors, higher votes signify more errors and lower vote values are indicative of successful matches; correct velocity pairs receive the votes with lower error values while incorrect ones receive votes with higher errors rates. This voting scheme presents several advantages. For example, regions of low texture may have a higher quality indicator because the probability of finding the reference image somewhere in the search area is high, these regions will cast votes for all velocities equally so it will not affect the voting result. An interesting effect comes for a given kernel, when an attempt is made to find a low texture region on a mixed search area. In this situation, it may not be possible to identify the location of the region, but the search will provide a very strong indication of where the region is not. Its vote will be counted and used to provide a strong rejection for the incorrect velocity pairs.

To allow for regions of the image with slightly different velocity vectors a smoothing operation is performed on the voting field before the votes are counted, which allows groups of closely located votes to reinforce each other while attenuating sparse and isolated ones.

6) Elastic Matrix Creation

When tracking a target, minimizing the effects of background pixels is a desirable goal. The challenge is that most target designations generated either manually or through an Automatic Target Recognition (ATR) system produce a rectangular area around the located target. The inherent difficulty with a rectangular target designator is that it may include large portions of background imagery along with the target. For the tracker to be effective it must ignore the background and concentrate on the target alone. One approach is to break up the target box into many smaller trackers and then independently track each of the segments. By analyzing the motion of each of the tracked segments it is possible to catalog and group the trackers into targets or static background objects.

The creation of the Elastic Matrix is composed of three major processes:

1) Creating the Candidate Targets

2) Assessing the Target Quality of the Candidate Targets

3) Creating the Elastic Matrix

7) Candidate Target Creation

The first step to creating a Target Cluster is to simply divide the area enclosed by the target designator into many small sub-images; each image is assigned its own tracker. Subsequently, the tracker evaluates the quality of each of the sub-images; areas of low texture and areas limited by the optical flow constrain are eliminated from consideration. When the second frame of video arrives after the target was designated, the system performs two major tasks: runs the Motion Fields algorithm and performs a Least Square Error tracking on all the remaining Candidate Targets.

For each of the trackers, the quality of the track and its correlation to the expected motion (from the Motion Fields results) is evaluated; trackers that did not produce a sharp correlation peak or whose track was outside of the expected motion are dismissed. The remaining trackers are grouped by motion similarity and an Elastic Matrix is created by linking each tracker with its closest neighbors.

8) Target Quality

After the target imagery is divided into many small, independently tracked targets, the quality of each of the targets is assessed in an effort to reduce the number of features to track to the set that is most likely to produce an unambiguous location during subsequent video frames.

The target quality is assessed by tracking the target on the same video frame from which it was extracted by using a convolution-based tracker. The results of the convolution operation at target locations surrounding the original position are saved into an array called the Correlation Surface; the shape of the surface can be analyzed to determine the quality of the target. We use a fairly easy and quick analysis technique by counting the number of correlation peaks and their slope. If we find more than one peak we look at the statistical distribution of the peaks on the correlation surface. If the peaks are few and tightly clustered, the standard deviation is small and the target is assigned a higher quality than a target with the same number of peaks but widely distributed.

9) Elastic Matrix Creation

For every candidate target, an Elastic Matrix Node is created. The node stores information relevant to tracking the individual target feature such as its position, velocity, track quality, number of frames tracked, number of frames of lost track, the voting database, the list of elastic relationships to other nodes, and a link to a Least Squares Error tracker dedicated to tracking the target from frame to frame.

For every pair of candidate targets, an Elastic Matrix Relationship is created; the Relationship keeps track of the data needed to predict the position of either one of targets in case of occlusion where only one of them can be located on the video frame. Each Relationship stores the offset position and speeds, as well as the distance and the weight of each of the trackers based on their track quality indicators. Each of the nodes in the Elastic Matrix keeps a list of the Relationships that links it to other nodes, and the list is kept sorted by relevance (closer higher quality nodes are kept first, followed by further high quality nodes, and finally low quality nodes).

10) Tracking with the Elastic Matrix

Once the Elastic Matrix is constructed, the tempo-spatial relations between the trackers in the cluster are established. These relationships are used to create local support groups where the apertures are combined, and to provide an elastic reference frame that trackers use to maintain cohesion. The Elastic Matrix is especially important for trackers that temporarily lost their targets, as they can use it to maintain their orientation and position as the target moves. For example, when the subject being tracked walks behind a partial foreground occlusion such as a column or another person, the trackers following the obscured features will maintain their position in relation to the features still visible. When the obscured features emerge on the opposite side of the obscuration, the corresponding trackers will be positioned correctly to reacquire track and help support the Elastic Matrix during subsequent frames.

During the tracking process, the Motion Fields results are used to guide the search algorithm. For example, if the Motion Fields indicate that a particular area of the image is moving with certain velocity and direction, the trackers working on that area will bias their search knowing that the target they are looking for is most probably moved in the direction indicated.

One of the most powerful features of the Cluster Tracker is its ability to perform a weighted aperture amalgamation of the trackers linked by the Elastic Matrix. During the amalgamation process, trackers with a higher track quality have a higher influence on tracking decisions than trackers that can't find their targets. Since the track qualities (and therefore the weights) are calculated during the initial phase of tracking, the Cluster Tracker automatically ignores features obscured by background or foreground interferences while seamlessly tracking the target using the combined aperture of the higher quality trackers. The Elastic Matrix maintains the low-quality trackers in position as the targets moves by extrapolating their location and velocity from their elastic relationships to the higher quality nodes. This ability allows the Cluster Tracker to maintain track lock even when the target goes through severe occlusion environments. As long as some part of the target is visible, the tracker can extrapolate the position of the rest of the trackers.

Tracking Individual Targets

Each of the trackers of the cluster produces a correlation surface by performing an intensity-based convolution operation of a reference image template and the current video frame. Each of the correlation surface elements is calculated as:

$${C}_{uv} = {\sum }_{x} {\sum }_{y} {( {T}_{xy} - {V}_{( x + u ) ( y + v ) )} )}^{2} , \qquad ( 5 )$$

where T_{xy} is the reference image and V_{xy} is the video fame. This process is straightforward for gray scale images, but for RGB color streams the difference operation must be computed in the three-dimensional vector space. The operation can be computed as the vectorial distance between the two colors expressed as vectors in the RGB space:
Dist(T,V)=\sqrt{(T_{R}−V_{R})²+(T_{G}−V_{G})²+(T_{B}−V_{B})²} (6)
The Vector Distance method can be implemented on hardware efficiently, requiring only integer registers and Arithmetic Logic Units (ALU).
Least Square Error Tracking

Once the correlation surface is built it is fairly straightforward to scan it by looking for the minimum value. Because each of the correlation surface values is derived from the number of errors between the reference template and the current video frame, the lowest value on the correlation surface corresponds to the least errors and therefore the best match. Once the correlation peak is found, it is necessary to determine the quality of the tracking operation, and so the operations are repeated as described in the above section describing how to extract a value that can be used when assessing the ‘trustworthiness’ of the tracker.

It is necessary to find a value that can be used as a weight when comparing this tracker to the other trackers on the same Elastic Matrix. In a preferred embodiment, the correlation peak value is used because it is a direct indicator of how closely matched are the reference template and the video frame. Because of the large dynamic range of the correlation peak, and because of the particular interest in and importance of the weight when the values are low, compression of the correlation value is obtained by using a logarithmic operator. In a preferred embodiment, it is desirable to have values between 0 and 1, and so, a negative exponential operation is used to force values of good correlation to be 1 and poor correlation values to asymptotically approach zero. The weight function is expressed as:
W(cv)=exp{−ln(cv)}, (7)
where c v is the correlation value at the peak of the correlation surface.
The Weighted Amalgamation Process

The amalgamation process is used to combine the tracking data of the small cluster trackers in order to increase their effective aperture. After selecting which trackers will participate on the voting process, the amalgamation process collects their votes in the form of their squared sum of errors at each of the possible motion vectors multiplied by a weight factor derived from their track quality. Effectively the trackers linked by the Elastic Matrix add their correlation surfaces, with the highest quality trackers having the most impact on the results.

By allowing the entire surface to vote, unlike the 4-D Tensor approach that allows only the peaks to vote, the system is able to cope with highly dynamic target imagery where features change appearance rapidly, sometimes a changing feature does not always match the template best, but if its motion is not corroborated by the other trackers the false peak can be overwritten by the strength of the neighbors' votes.

The votes are collected on a second correlation surface called the Voting Surface. This second correlation surface is kept at the Elastic Matrix Node and is used exclusively by the Elastic Matrix to calculate the most probable position of the target feature. In a preferred embodiment the Elastic Matrix Node runs a second tracking algorithm on the Voting Surface; since the Voting Surface has a much higher aperture than that of the individual trackers it is more robust to local obscurations and background interferences.

The weighting operation is what enables the tracker to automatically and seamlessly switch tracking references from its own tracker to the combined reference supported by the other trackers in its Elastic Matrix vicinity. The weight values Wₙ are derived from both the track quality and the distance to the voting member where the weights are used to build a matrix where each of the vertexes are calculated as:

$${C}_{uv} = \frac{{\sum }_{n} {W}_{n} C {V}_{uvn}}{{\sum }_{n} {W}_{n}} , \qquad ( 8 )$$

where CVᵤᵥₙ is the correlation value of neighbor n at location u,v.
Vote Tallying and Tracking

Taking a layered approach, each of the velocity pairs (vx, vy) can be viewed as a layer on a 4-Dimensional array of dimensions (x, y, vx, vy). The layered view allows the segregation of trackers of similar motion characteristics because those nodes will have components on similar layers; votes take place on layers, one layer per velocity pair. For example, a tracker with a strong peak at (vx1, vy1) places a strong vote on that layer on its neighbor's Voting Surface. At the end of voting, the layers are analyzed and groups of nodes with similar motion vectors that reinforce each other quickly dominate while insulated votes that receive little support are dismissed. The velocity pair layer with the most support decides the final tracking results for each of the trackers.

Adjusting the Elastic Matrix

After the voting process, all the trackers in the matrix have an estimated position and velocity, as well as their own track quality indicator. The next step is to update the Elastic Matrix links. This operation is not as straightforward as one might think because the matrix needs to be elastic to follow the subject as it moves yet rigid enough to provide support to nodes of lesser quality. It must also act as a coherency agent and keep nodes from flying away in all directions, even if the nodes are of high quality themselves.

The first step is to rank the trackers relative to each other according to their track quality. For this we simply find the maximum and minimum values and assign the relative quality from 0 to 10 according to where in the range a tracker's quality value falls. If all the trackers are of very similar quality we assign all of them the maximum value.

The second step is to initialize the nodes of the matrix corresponding to the highest-ranking trackers, so we move all the nodes with a quality rank of 8 or better to their tracker own locations.

The last step is to iteratively approximate the node locations to the tracker's using a weighted voting scheme and the known relationships of each of the nodes in the matrix to each other. For each node in the matrix a weighted vote is taken from all its selected neighbors. The vote consists on the predicted location of the node multiplied by the weight calculated during the amalgamation process. Each of the links in the Elastic Matrix stores the position and speed offsets between its two endpoint nodes. The prediction process takes the first node's current position and speed and using the offsets it calculates the second node's position. As the iterative process moves the nodes it converges to an equilibrium point usually in less than four iterations. The resulting node position is a balance of the node's own tracking results and the predicted position from the linked nodes, heavily influenced by all the node's weights. The iterative voting has several effects; it provides support to nodes with poor tracking, and keeps the matrix as a coherent unit by keeping nodes from floating away.

### EXAMPLE 1 TENSOR VOTING SCHEME PERFORMANCE

Experiments have been performed to demonstrate the performance of the modified 4-D Tensor Voting Scheme. Experimental results show that implementation of the 4-D Tensor Voting scheme with a limited radius voting neighborhood does result in improved computational speed. The simplified approach gives comparable results to classical Tensor Voting framework, but a 700 token field takes approximately 5 seconds to process using a classical Tensor Voting framework while the simplified version takes about 0.25 seconds. (Pentium IV, 2.6 GHz)

### EXAMPLE 2 TRACKING PERFORMANCE

The Cluster Tracker was tested in a variety of controlled and uncontrolled environments, including a mall and a skating rink. The controlled tests consisted of a sequence with a static complex background and a single subject walking perpendicularly to the camera; a assortment of synthetic foreground obscurations were superimposed to the video prior to tracking in order to observe the tracker performance under several degrees of occlusion severity.

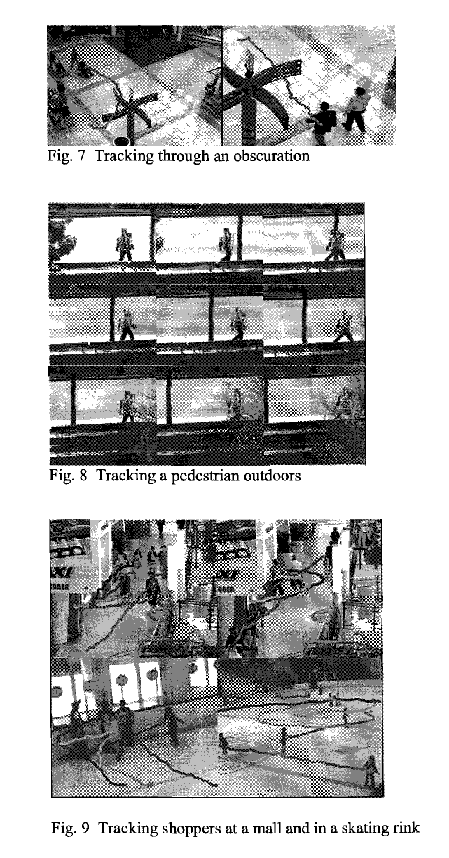

The performance of the Cluster Tracker when part of the target is obscured by different foreground obstacles is seen in FIG. 6. It is found that the tracker is able to maintain track even in the presence of very severe line of sight obscurations where only small portions of the target are visible. Similar performance was observed when severe obscurations occur with obstacles of similar coloration and texture as the target as shown in FIGS. 7 and 8.

Tracking outdoors presents a special challenge because such environments are typically complex and unpredictable. In FIG. 8, the tracking of a pedestrian as he walks behind a couple of severe obscurations is shown.

Tracking people in a crowd presents a difficult problem mainly because of the highly dynamic background and the fact that subjects tend to occlude each other. The Cluster Tracker mitigates the problem because is able to ignore the background and it can maintain lock as long as some part of the target remains visible as shown in FIG. 9

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method for tracking moving objects from data by tracking a cluster of resilient features of the target, said features corresponding to a set of trackers, so as to maintain tracking or allow rapid reacquisition and subsequent tracking although the objects form and geometry may change, the method comprises:
a Motion Fields Extraction step,
a Creation of the Elastic Matrix step, and
a step comprising the recurring tracking of the target, and said Motion Fields Extraction step further comprises the steps: Generate Candidate Matches, Localized Motion Voting, and Voting Resolution, and said Creation of the Elastic Matrix step comprises the three steps of Creating the Candidate Targets, Assessing the Target Quality of the Candidate Targets, and Creating the Elastic Matrix.

2. The method of claim 1 in which the object or objects being tracked are human persons or animals.

3. The method of claim 1 in which the data include the disturbances induced by background and foreground objects.

4. The method of claim 1 in which the positions of the occluded features of the target are extrapolated or predicted by the position and velocity parameters of the visible features.

5. The method of claim 1 in which the cohesiveness of the cluster is maintained by a collective vote process by the individual trackers.

6. The method of claim 1 in which the position, velocity, selection, inclusion, ranking, or weights of individual trackers are influenced by the results of the collective vote.

7. The method of claim 1 in which the trackers with highest tracking quality have more weight on the voting process.

8. The method of claim 1 in which the trackers further away from the vote center have lower weight on the voting process.

9. The method of claim 1 in which the tracking quality indicator is derived from the correlation surface peak or notch value.

10. The method of claim 1 in which the trackers are ranked by their tracking quality indicators.

11. The method of claim 1 in which the trackers that are linked by Elastic Matrix relationships have correlation surfaces combined according to their tracking quality weight.

12. A method for tracking moving objects from data by tracking a cluster of resilient features of the target, said features corresponding to a set of trackers, so as to maintain tracking or allow rapid reacquisition and subsequent tracking although the objects form and geometry may change, the method comprises:
a Motion Fields Extraction step,
a Creation of the Elastic Matrix step, and
a step consisting of the recurring tracking of the target, and said Elastic Matrix is continually updated,
and weighted voting and voting resolution are used in the said Motion Field Extraction and the said Creation of the Elastic Matrix steps.

13. A method for tracking one or more moving targets as objects from data in a sequence of image frames by tracking a cluster of resilient features of the target, said features corresponding to a set of trackers, so as to maintain tracking or allow rapid reacquisition and subsequent tracking although the objects form and geometry may change, the method comprises:
a step in which the target objects are initially designated in a target designation window that includes the target and its vicinity in the image frame,
a step in which the target designation window is segmented into multi-pixel patches that each comprise a template for a pixel-by pixel convolution with candidate matching regions of a successive image frame,
a step of performing a set of said pixel-by-pixel convolutions and calculating weighted convolution surfaces in a phase space,
a step of performing weighted voting and voting resolution to determine the best quality Motion Field,
a step of using the Motion Field to identify good candidate features of the target,
a step in which said good quality features are then used as trackers in a weighted voting process with voting resolution to create an Elastic Matrix that comprises nodes of data that correspond to a cluster of trackers,
a step wherein the cluster of trackers are tracked in successive image frames, and said Elastic Matrix is updated as targets are tracked in succeeding frames.
